(19) United States
(12) Patent Application Publication
(10) Pub. No.: US 2005/0185140 A1
(43) Pub. Date: Aug. 25, 2005

(54) Lighting device and projection type display system

(75) Inventors: Takayuki Matsubara, Suwa-shi (JP); Masatoshi Yonekubo, Hara-mura (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/059,340

(22) Filed: Feb. 17, 2005

(30) Foreign Application Priority Data
Feb. 23, 2004 (JP) 2004-046156

(51) Int. Cl. G03B 21/14

(52) U.S. Cl. 353/20

(57) ABSTRACT

To provide a miniaturized lighting device that emits light appropriate for illumination of a display system and a projection type display system including the lighting device. A lighting device includes solid-state light sources to emit light, light introducing elements to equalize an illumination distribution of the light emitted from the solid-state light sources, and reflection type polarizing elements into which the light emitted from the solid-state light sources is introduced. The lighting device is characterized in that the reflection type polarizing elements are disposed inside the light introducing elements or on light exit end faces of the light introducing elements, and that the solid-state light sources reflect the light which has been reflected by the reflection type polarizing elements.

### BACKGROUND

Exemplary aspects of the present invention relate to a lighting device and a projection type display system.

There is increasing demand for a thin and low power consumption type display system having a high resolution. Thus, research and development have been proceeding in this field to meet this requirement. Liquid crystal display systems have been expected to be capable of satisfying the above need by electrically controlling arrangements of liquid crystal molecules to vary its optical characteristics. Related art liquid crystal display systems include a projection type display system (projector) to project enlarged images on a screen through a projection lens, which images are emitted from an image source including an optical system which is provided with a liquid crystal light valve.

Related art lighting devices used in the projection type display system involve those having a light source, such as a metal halide lamp, an extra-high pressure mercury lamp and a halogen lamp. Light emitted from those light sources, however, generally have non-uniform illumination distributions. Thus, a lighting device which includes an optical element provided with a rod-shaped light introducing body in its uniform illumination system has been disclosed so as to equalize an illumination distribution in a region to be illuminated, or more specifically, in a display surface of a liquid crystal light valve as a light modulation device. See JP-A-10-163533, JP-A-2000-180962 and JP-A-11-352589.

### SUMMARY

In JP-A-10-163533, JP-A-2000-180962 and JP-A-11-352589, the rod-shaped light introducing body is used only for equalization of the illumination distribution and collimation of the light emitted from the light source. Thus, additional optical elements, such as a polarizing element and a light equalizing element are required when the above-described lighting device is employed for the illumination of the projection type display system or other equipment, which makes it difficult to miniaturize the projection type display system or other equipment.

Exemplary aspects of the present invention address and/or solve the above-described and/or other problem. Exemplary aspects of the invention provide a lighting device which is small-sized and capable of emitting light appropriate for the illumination of a display system and provide a projection type display system including the lighting device.

In order to achieve the above, a lighting device of a first exemplary aspect of the present invention includes: a solid-state light source to emit light; a light introducing element to equalize an illumination distribution of the light emitted from the solid-state light source; and a reflection type polarizing element into which the light emitted from the solid-state light source is introduced. The lighting device is characterized in that the reflection type polarizing element is disposed inside the light introducing element or on a light exit end face of the light introducing element, and that the solid-state light source reflects the light which has been reflected by the reflection type polarizing element.

In the lighting device of the first exemplary aspect of the invention, the reflection type polarizing element is disposed inside the light introducing element or on the light exit end face of the light introducing element. Thus, the lighting device can emit light which is one of linearly polarized lights crossing each other at right angles and has an equalized illumination distribution.

Since the lighting device emits light which is one of the polarized lights and has a uniform illumination distribution appropriate for a projection type liquid crystal display system, for example, the lighting device can be employed in the projection type liquid crystal display system without requiring additional polarizing elements. Thus, the projection type display system can be made compact.

Moreover, the other linearly polarized light reflected by the reflection type polarizing element is converted into the opposite linearly polarized light while being repeatedly reflected between the solid-state light source and the reflection type polarizing element, and finally comes to pass through the reflection type polarizing element. As a result, lowering of utilization efficiency of the light emitted from the solid-state light source is reduced or prevented, and thus bright light appropriate to illuminate the liquid crystal display system can be generated.

A lighting device of a second exemplary aspect of the present invention includes: a solid-state light source to emit light; a light introducing element to equalize an illumination distribution of the light emitted from the solid-state light source; and a light diffising element into which the light emitted from the solid-state light source is introduced. The lighting device is characterized in that the light diffusing element is disposed inside the light introducing element or on a light exit end face of the light introducing element.

In the lighting device of the second exemplary aspect of the invention, the light diffusing element is disposed inside the light introducing element or on the light exit end face of the light introducing element. Thus, the lighting device can emit light having a more uniform illumination distribution since the illumination distribution which has been equalized by the light introducing element is further equalized by the light diffusing element.

Accordingly, if the illumination distribution equalized only by the light introducing element is inappropriate (insufficiently equalized) to illuminate the projection type liquid crystal display system, the illumination distribution can be further equalized without requiring additional equalization of the illumination distribution. Consequently, the projection type display system can be miniaturized.

In a particular example of the above-described structure, at least a peripheral portion of a light entrance end face of the light introducing element may directly contact a light exit end face of the solid-state light source.

According to this structure, the light emitted from the solid-state light source can be directly introduced into the light introducing element since the solid-state light source directly contacts the light introducing element. Thus, the light emitted from the solid-state light source is difficult to leak outside, thereby reducing or preventing lowering of the light utilization efficiency.

In a particular example of the above-described structure, the light introducing element may be made only from a light transmissible material.

According to this structure, the light having entered the light introducing element propagates within the light transmissible material while being totally reflected. As a result, the illumination distribution is equalized.

Moreover, the space occupied by the light introducing element is smaller than that occupied by a fly's eye lens for similarly equalizing illumination distribution. Thus, the lighting device can be miniaturized.

In a particular example of the above-described structure, a reflection film to reflect light may be formed on a surface other than the light entrance end face and the light exit end face of the light introducing element.

According to this structure, light entering a face other than the light entrance end face and the light exit end face of the light introducing element at an angle larger than the total reflection angle can also be reflected, and thus the illumination distribution can be equalized. It is therefore possible in this structure to reflect the light which is not totally reflected but passes through the face other than the light entrance end face and the light exit end face of the light introducing element. As a result, the utilization efficiency of the light emitted from the solid-state light source is more enhanced compared with the structure which does not include the reflection film on the face other than the light entrance end face and light exit end face.

In a particular example of the above-described structure, the light introducing element may be formed by arranging reflection plates for reflecting light in the shape of a hollow column, and inside surfaces of the hollow column may include light reflection surfaces of the reflection plates.

According to this structure, the light having entered the light introducing element propagates within the inside surfaces of the hollow column formed by the reflection plates while being totally reflected. As a result, the illumination distribution of the light is equalized.

Moreover, the space occupied by the light introducing element is smaller than that occupied by a fly's eye lens for similarly equalizing illumination distribution. Thus, the lighting device can be small-sized.

In a particular example of the above-described structure, the shape of the light exit end face of the light introducing element may be similar to the shape of the object to be illuminated.

According to this structure, the light coming from the light exit end face of the light introducing device can be supplied to the object to be illuminated without any loss. Thus, the utilization efficiency of the light emitted from the solid-state light source is enhanced.

Specifically, since the shape of the light exit end face is similar to the shape of the object to be illuminated, the illumination region of the light coming from the light exit end face can be matched with the shape of the object to be illuminated by interposing an appropriate optical system therebetween. As a result, the utilization efficiency of the light emitted from the solid-state light source can be enhanced.

In a particular example of the above-described structure, the light introducing element may have a straight shape whose cross-sectional area is constant from the solid-state light source to the object to be illuminated.

According to this structure, the space occupied by the straight-shaped light introducing element is smaller than that occupied by a tapered light introducing element. Thus, the lighting device can be made compact.

In a particular example of the above-described structure, the light introducing element may have a tapered shape whose cross-sectional area increases from the solid-state light source to the object to be illuminated.

According to this structure, the light is collimated (parallelized) every time it is repeatedly reflected within the light introducing element. Thus, the tapered light introducing element can emit more collimated light than light emitted from the straight-shaped light introducing element.

In a particular example of the above-described structure, a single piece of the solid-state light source corresponds to a single piece of the object to be illuminated.

According to this structure, the space occupied by the lighting device is smaller than that occupied by a lighting device in which a plurality of the solid-state light sources are provided for a single piece of the object to be illuminated. Thus, the lighting device can be miniaturized. When the lighting device having the structure of this example is included in a projection type display system, for example, the projection type display system can be small-sized.

In a particular example of the above-described structure, a plurality of the solid-state light sources correspond to a single piece of the object to be illuminated.

According to this structure, a larger amount of light can be supplied to the object to be illuminated than in the lighting device in which a single piece of the solid-state light source is provided for a single piece of the object to be illuminated. When the lighting device having the structure of this example is included in a projection type display system, for example, the projection type display system can produce images having higher brightness.

A projection type display system of an exemplary aspect of the present invention includes: a lighting device to emit light; a light modulating device to modulate the emitted light; and projector to project the modulated light. The projection type display system is characterized in that the lighting device included is one of the above-described lighting devices of an exemplary aspect of the present invention.

The projection type display system according to an exemplary aspect of the invention is made compact and capable of producing images having uniform brightness by employing one of the above-described lighting devices of an exemplary aspect of the invention.

### BRIEF DESCRIPTION OF THE DRAWINGS

FIG. 1 is a schematic of a projection type display system in a first exemplary embodiment of the present invention;

FIG. 2 is a schematic of a tapered rod lens in the first exemplary embodiment;

FIG. 3 is a schematic of a WGP in the first exemplary embodiment;

FIG. 4 is a schematic of another tapered rod lens in the first exemplary embodiment;

FIG. 5 is a schematic of an operation of the tapered rod lens in the first exemplary embodiment;

FIG. 6 is a schematic of another projection type display system in the first exemplary embodiment;

FIG. 7 is a schematic of another tapered rod lens in the first exemplary embodiment;

FIG. 8 is a schematic of still another tapered rod lens in the first exemplary embodiment;

FIGS. 9(a) and FIG. 9(b) are schematics of still another tapered rod lens each in the first exemplary embodiment;

FIG. 10 is schematic of a projection type display system in a modified example of the first exemplary embodiment;

FIG. 11 is a schematic of a lighting device in the modified example of the first exemplary embodiment;

FIG. 12 is a schematic of a projection type display system in a second exemplary embodiment;

FIG. 13 is a schematic of a projection type display system in a third exemplary embodiment;

FIG. 14 is a schematic of a light diffusing element in the third exemplary embodiment; and

FIGS. 15(a) through 15(c) are schematics of another light diffusing element each in the third exemplary embodiment.

### DETAILED DESCRIPTION OF EXEMPLARY EMBODIMENTS

Exemplary Embodiment 1

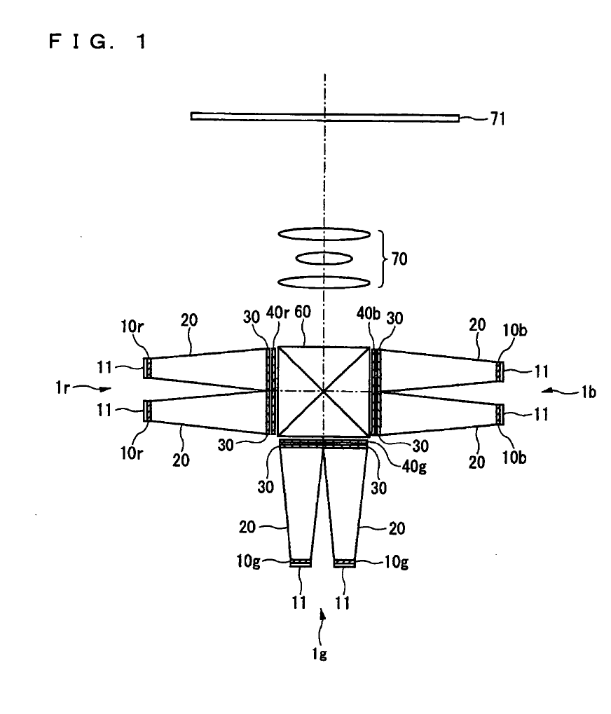

A first exemplary embodiment of the present invention is hereinafter described in conjunction with FIGS. 1 through 9.

A projection type display system in the first exemplary embodiment of the invention is first explained with reference to FIG. 1. The projection type display system in this exemplary embodiment is a triple-plate projection type color display system which spatially modulates three different lights of R (red), G (green) and B (blue) emitted from a solid-state light source by corresponding liquid crystal light valves and synthesizes the modulated lights by a cross dichroic prism to produce color images.

FIG. 1 is a schematic of the projection type display system in this exemplary embodiment.

As shown in FIG. 1, the projection type display system generally includes lighting devices 1r, 1g and 1b to emit different R, G and B lights, respectively, liquid crystal light valves (object to be illuminated; light modulating device) 40r, 40g and 40b to spatially modulate the respective lights, a cross dichroic prism 60 to synthesize the modulated respective lights to produce color images, and projection lenses (projecting means) 70 to project the color images.

The lighting devices 1r, 1g and 1b include LEDs (solid-state light source) 10r, 10g and 10b, respectively, to emit illumination lights having respective colors, tapered rod lenses (light introducing element) 20 to equalize the illumination distributions of the respective lights, and WGPs (Wire Grid Polarizer; reflection type polarizing element) 30.

The LEDs 10r, 10g and 10b emit the R, G and B lights, respectively, when electric power is supplied. Light source reflection films 11 are disposed on the LEDs 10r, 10g and 10b to reflect the light coming from the light exit sides of the tapered rod lenses 20 toward the tapered rod lenses 20 again.

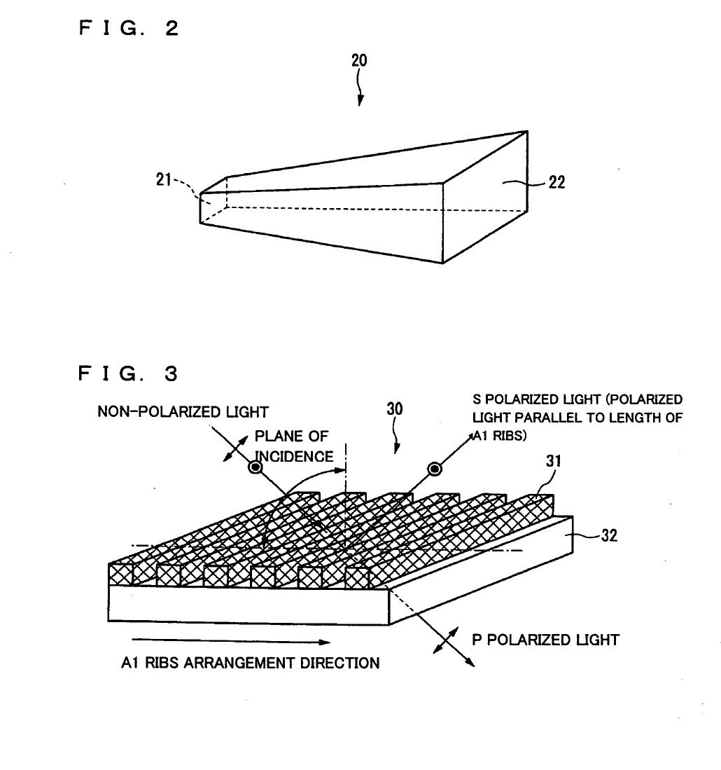

FIG. 2 is a schematic of the tapered rod lens in this exemplary embodiment.

The tapered rod lens 20 is a solid in the shape of a square pole which is made from light transmissible material, such as glass and resin. As illustrated in FIGS. 1 and 2, the tapered rod lens 20 is shaped such that the cross-sectional area thereof gradually increases from an end face (light entrance end face) 21 to the other end face (light exit end face) 22. The respective tapered rod lenses 20 are also formed such that the shapes of the light entrance end faces 21 correspond to the shapes of the LEDs 10r, 10g and 10b, and components having high refractive index, such as silicone gel are interposed between the end faces 21 and the LEDs 10r, 10g and 10b so as to reduce or prevent reduction of the introduction rate of the light into the tapered rod lenses 20.

Thus, one tapered rod lens 20 is provided on each of the LEDs 10r, 10g and 10b. Since an LED widely used at present is several millimeters in length and width, for example, the end face 21 is formed to correspond to this size, i.e., several millimeters in length and width.

One tapered rod lens 20 maybe provided on each of the LEDs 10r, 10g and 10b as described above, or one tapered rod lens 20 may be arranged to correspond to a plurality of the LEDs 10r, 10g and 10b.

Additionally, the tapered rod lenses 20 are disposed in such positions that the light exit end faces 22 are opposed to the liquid crystal light valves 40r, 40g and 40b, and that respective pairs of the end faces 22 form the same shapes as those of the light entrance faces of the liquid crystal light valve 40r, 40g and 40b by positioning the respective pairs of the tapered rod lenses 20 in parallel as illustrated in FIG. 1.

Each pair of the tapered rod lenses 20 may be disposed in parallel as described above, or more than two tapered rod lenses 20 may be arranged in parallel or in a matrix.

FIG. 3 is a schematic of the WGP in this exemplary embodiment.

The WGP 30 is so formed as to have the same shape as that of the end face 22 of the tapered rod lens 20 as illustrated in FIG. 1, and to directly contact the end face 22. The structure in which the WGP 30 directly contacts the end face 22 reduces or prevents leakage of light from a clearance between the end face 22 and the WGP 30, thereby avoiding lowering of the light utilization efficiency.

As illustrated in FIG. 3, the WGP 30 is a grid polarizer having a number of ribs 31 on a glass substrate 32, which ribs are made from metal having light reflection property, such as aluminum. The ribs 31 are provided with a pitch smaller than the wavelength of incident light.

The reflection type polarizer to be employed is not specifically limited, which may be formed by the WGP 30 as described above or by a film multilayered laminated polarizer, for example.

Additionally, the WGP 30 and the tapered rod lens 20 may be equipped separately, or the WGP 30 may be directly formed on the end face 22 of the tapered rod lens 20. The structure in which the WGP 30 is directly formed on the end face 22 reduces or prevents leakage of light from the clearance between the end face 22 and the WGP 30, thereby avoiding lowering of light utilization efficiency.

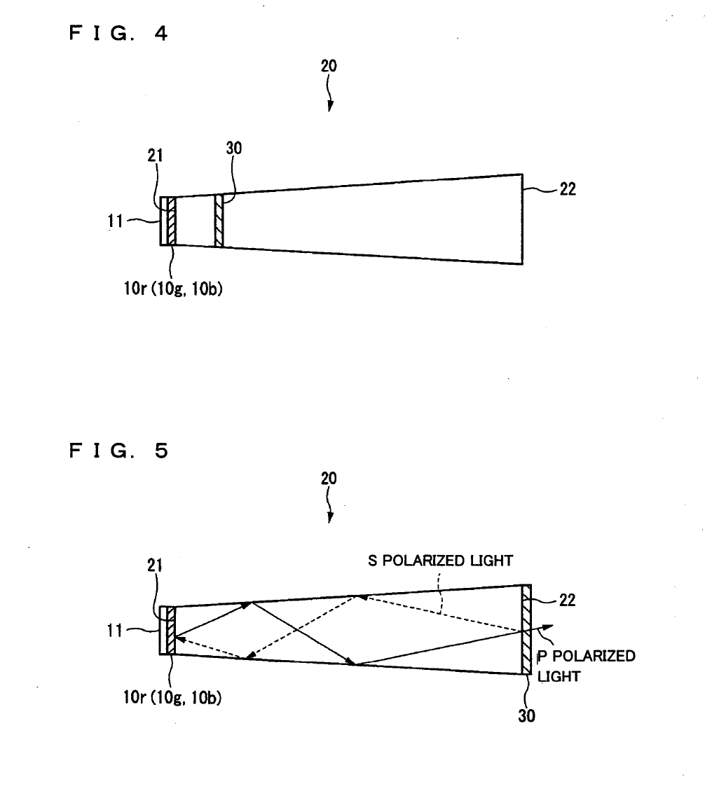

The WGP 30 may be disposed on the end face 22 such that the WGP 30 contacts the end face 22 as described above, or may be positioned inside the tapered rod lens 20, i.e., between the end face 21 and the end face 22 as illustrated in FIG. 4.

Each of the liquid crystal light valves 40r, 40g and 40b includes an active matrix type light transmissible liquid crystal panel in which image display pixels are arranged in a matrix. The active matrix type light transmissible liquid crystal panel is so operated as to vary transmittance of incoming light by pixel in accordance with signal-processed image signals (i.e., to conduct spatial modulation). Specifically, the transmittance of light is determined in a range from approximately 0% to 100% by controlling voltage applied to a light transmissible electrode of the liquid crystal light valve.

Each of the liquid crystal light valves 40r, 40g and 40b also includes active matrix type light transmissible liquid crystal cells in TN (Twisted Nematic) mode which use thin film transistors (hereinafter “TFTs”) as pixel switching elements.

The liquid crystal light valves 40r, 40g and 40b are disposed such that the modulated lights of respective colors enter corresponding different faces of the cross dichroic prism 60.

The cross dichroic prism 60 is formed by combining rectangular prisms, and a mirror face to reflect the red light and a mirror face to reflect the blue light are formed crosswise on the inside surfaces of the cross dichroic prism 60. The lights of three different colors are synthesized using these mirror faces so as to generate light to produce color images.

Projection lenses 70 are disposed on the exit side of the cross dichroic prism 60 from which the light to produce color images are released. The projection lenses 70 project the light to produce color images on a screen 71.

Next, the operation of the projection type display system having the above-described structure is explained.

Since the actions of the lights of the respective colors emitted from the LEDs 10r, 10g and 10b are similar to each other, only the action of the R light emitted from the LED 10r is mentioned and the description of the actions of the other G and B lights is herein omitted.

When electric power is supplied to the LED 10r, the LED 10r emits the R light toward the tapered rod lenses 20 as illustrated in FIG. 1.

FIG. 5 is a schematic of the operation of the tapered rod lens.

As shown in FIG. 5, the R light having entered the tapered rod lens 20 propagates toward the end face 22 while repeating total reflections within the tapered rod lens 20, thereby obtaining a uniform illumination distribution. The R light is also collimated (parallelized) every time it is totally reflected within the tapered rod lens 20 in the course of propagation toward the end face 22. Then, the R light is released from the end face 22 toward the WGP 30.

When the R light (randomly polarized light) reaches the WGP 30, it enters the side where A1 ribs 31 are formed as illustrated in FIG. 3. In the R light having entered this side, s polarized light which vibrates in a direction parallel to the direction where the A1 ribs 31 extend is reflected, and p polarized light which vibrates in a direction perpendicular to the direction where the A1 ribs 31 extend (A1 ribs arrangement direction) is transmitted.

The s polarized light of the R light reflected by the WGP propagates within the tapered rod lens 20 toward the LED 10r to enter the LED 10r. The R light thus entering the LED 10r is again reflected toward the WGP 30 by the light source reflection film 11.

The s polarized light which does not pass through the WGP 30 goes back and forth between the WGP 30 and the light source reflection film 11 in the tapered rod lens 20 in the manner as described above. However, the s polarized light does not maintain its polarization direction all the time. A part of the s polarized light is converted into p polarized light by the rotation of the polarization direction which is caused when the s polarized light is reflected by the inside surfaces of the tapered rod lens 20.

When the light in the p polarized condition reaches the WGP 30, it passes through the WGP 30.

The p polarized light of the R light having passed through the WGP 30 as described above enters the liquid crystal light valve 40r, where the p polarized light is modulated in accordance with the image signals stored in the projection type display system and released toward the cross dichroic prism 60.

Similarly, p polarized light of the G light and p polarized light of the B light which are modulated in accordance with the image signals enter the cross dichroic prism 60. These lights are synthesized by the mirror to reflect the red light and the mirror to reflect the blue light to generate light which produces color images. The light to produce color images is subsequently released toward the projection lenses 70. The projection lenses 70 enlarge the light to produce color images and project it on the screen 71 so as to produce color images thereon.

According to the above-described structure, the lighting devices 1r, 1g and 1b emit p polarized light having uniform illumination distribution appropriate for the projection type liquid crystal display system. Since the lighting devices 1r, 1g and 1b are included in the projection type liquid crystal display system without adding polarizing elements, the projection type liquid crystal display system can be small-sized.

Additionally, the s polarized light reflected by the WGP 30 is converted into the p polarized light while being repeatedly reflected between the light source reflection film 11 and the WGP 30, and then passes through the WGP 30. It is thus possible to reduce or prevent lowering of utilization efficiency of the light emitted from the LEDs 10r, 10g and 10b and generate bright light suitable for the illumination of the projection type liquid crystal display system.

Since the LEDs 10r 10g and 10b directly contact the tapered rod lenses 20, the light emitted from the LEDs 10r, 10g and 10b is directly introduced into the tapered rod lenses 20. As a result, the light emitted from the LEDs 10r, 10g and 10b is difficult to leak outside, thereby reducing or preventing lowering of the light utilization efficiency.

The lighting devices 1r, 1g and 1b in this exemplary embodiment supply a larger amount of light to the liquid crystal light valves 40r, 40g and 40b, respectively, compared with a structure where a single piece each of the LEDs 10r, 10g and 10b are provided for the liquid crystal light valves 40r, 40g and 40b, respectively. Consequently, the projection type display system in this exemplary embodiment can produce bright images.

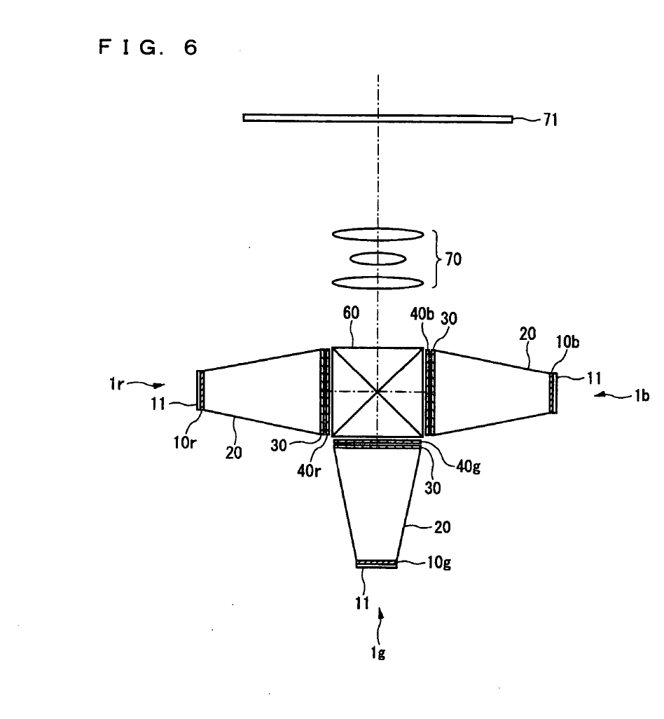

It is possible to dispose a single piece of the liquid crystal light valve corresponding to a plurality of the tapered rod lenses 20 and the LEDs as described above, or to only a single piece of the tapered rod lens 20 and the LED as illustrated in FIG. 6.

The structure illustrated in FIG. 6 allows the space occupied by the lighting devices 1r, 1g and 1b to be smaller than in the structure where a single piece of the liquid crystal light valve corresponds to a plurality of the tapered rod lenses 20 and the LEDs. Thus, the lighting devices 1r, 1g and 1b can be miniaturized.

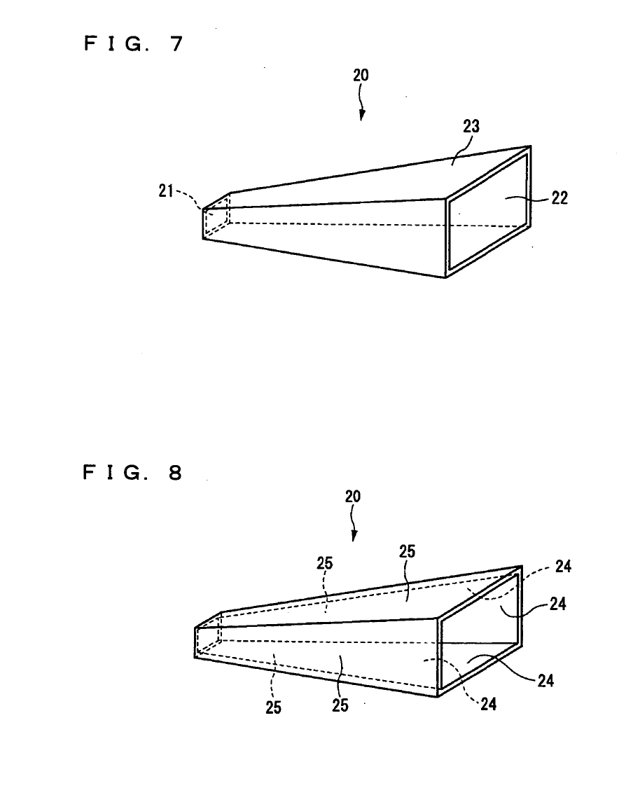

FIG. 7 is a schematic another example of the tapered rod lens.

The tapered rod lens 20 may be a solid made only from a light transmissible material as described above, or may have reflection films 23 to reflect light on the side faces (faces other than light entrance end face 21 and the light exit end face 22) as illustrated in FIG. 7.

According to this structure, light entering faces other than the end faces 21 and 22 of the tapered rod lens 20 at an angle larger than the total reflection angle can also be reflected, thereby further equalizing the illumination distribution. It is thus possible in this structure to reflect the light which is not totally reflected but passes through the faces other than the end faces 21 and 22 of the tapered rod lens 20. As a result, utilization efficiency of the light emitted from the LEDs 10r, 10g and 10b can be more enhanced compared with a structure which does not include the reflection films 23 on the faces other than the end faces 21 and 22.

FIG. 8 is a schematic of still another example of the tapered rod lens.

The tapered rod lens 20 may be a hollow rod formed by combining reflection plates 25, such as glass and sheet metal each having a reflection face (light reflection face) 24 in the shape of a hollow column as illustrated in FIG. 8.

This structure allows the illumination distribution of the light having entered the tapered rod lens 20 to be equalized since the light propagates in the inside surfaces (reflection faces 24) of the hollow column formed by the reflection plates 25 while being reflected. Additionally, as the space occupied by the element is smaller than that occupied by a fly's eye lens, the lighting device can be miniaturized.

When the reflection plates 25 are made from sheet metal to form the tapered rod lens 20 as a metal mirror hollow column, the tapered rod lens 20 can be manufactured relatively easily by press working of sheet metal.

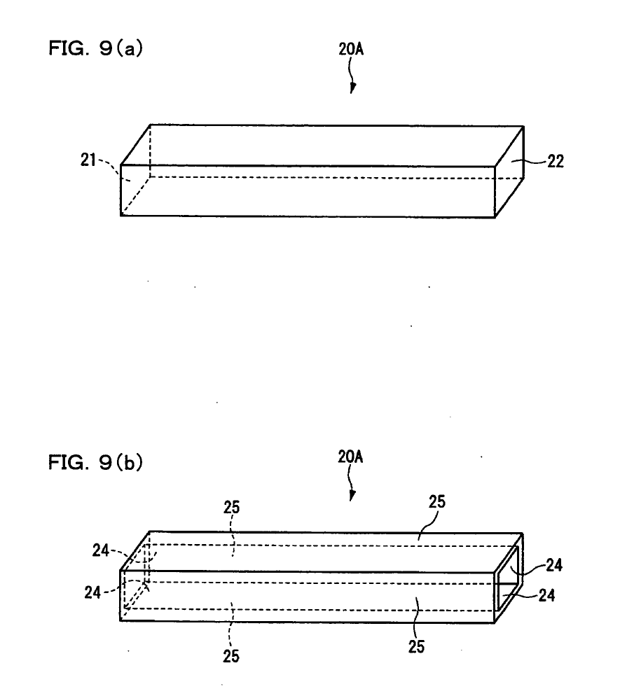

FIGS. 9(a) and 9(b) are schematics of still other examples of the tapered rod lens each.

The tapered rod lens 20 may have a tapered shape as described above, or may be a solid rod lens 20A made from the light transmissible materials, in the shape of a square pole which has uniform cross-sectional area and cross-sectional configuration from the end face 21 to the other end face 22 as illustrated in FIG. 9(a) or a hollow rod in the shape of a hollow column formed by combining the reflection plates 25 provided with the reflection faces 24 as illustrated in FIG. 9(b).

According to the structures of these examples, the space occupied by the rod lens 20A is smaller than that occupied by the rod lens having a tapered configuration. Thus, the lighting devices 1r, 1g and 1b can be small-sized.

Modified Example 1 of Exemplary Embodiment 1

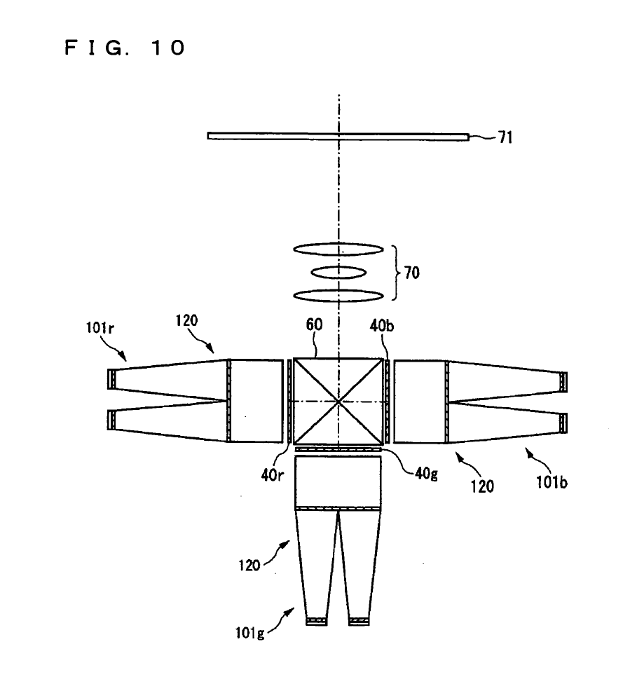

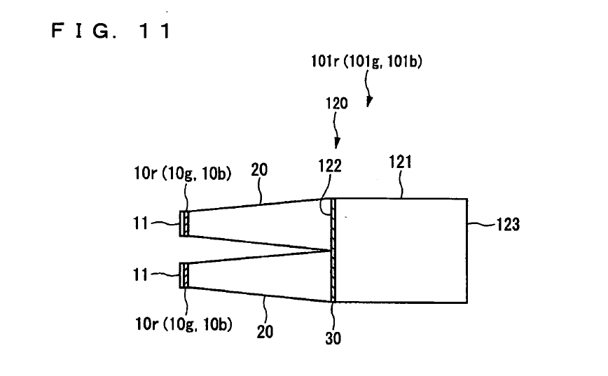

Next, a first modified example of the first exemplary embodiment of the invention is described with reference to FIGS. 10 and 11.

The basic structure of a projection type display system in this modified example is similar to that of the first exemplary embodiment, but the modified example is different from the first exemplary embodiment in the structure of the lighting devices. Therefore, only the lighting devices and their peripherals are described with reference to

FIGS. 10 and 11 and explanation of the liquid crystal light valves and other components are omitted in this example.

FIG. 10 is a schematic of a projection type display system in the modified example.

As shown in FIG. 10, the projection type display system generally includes lighting devices 101r, 101g and 101b to emit different R, G and B lights, respectively, the liquid crystal light valves 40r, 40g and 40b to spatially modulate the respective lights, the cross dichroic prism 60 to synthesize the modulated respective lights to produce color images, and the projection lenses 70 for projecting the color images.

FIG. 11 is a schematic of the lighting device in this modified example.

As shown in FIG. 11, the lighting devices 101r, 101g and 101b include the LEDs 10r, 10g and 10b, respectively, to emit illumination lights having respective colors, rod lenses (light introducing elements) 120 to equalize the illumination distributions of the respective lights, and the WGPs 30.

The rod lens 120 includes a main rod lens (light introducing element) 121 and the tapered rod lenses 20. The main rod lens 121 is a solid in the shape of a square pole which is made from light transmissible material, such as glass and resin. The main rod lens 121 is so shaped as to have uniform cross-sectional area and cross-sectional configuration from an end face (light entrance end face) 122 to the other end face (light exit end face) 123. The main rod lens 121 is also formed such that the shape of the light exit end face 123 corresponds to the shape of the liquid crystal light valve.

The operation of the projection type display system having the above structure is now described.

Since the actions of the lights of the respective colors emitted from the LEDs 10r, 10g and 10b are identical to each other, only the action of the R light emitted from the LED 10r is herein described and the explanation of the actions of the other G light and B light is omitted.

As the processes in this example are similar to those in the first exemplary embodiment from supplying electric power to the LED 10r until the p polarized light of the R light passes through the WPG 30 as illustrated in FIGS. 1 and 2, the explanation of the processes concerned is herein omitted.

The p polarized light of the R light having passed through the WGP 30 is introduced from the end face 122 into the main rod lens 121. The p polarized light repeats total reflections in the main rod lens 121 so as to further equalize its illumination distribution, and is subsequently released from the end face 123 toward the liquid crystal light valve 40r.

The action of the p polarized light of the R light after having entering the liquid crystal light valve 40r is the same as that in the first exemplary embodiment, the explanation of the action concerned is omitted.

According to the above-described structure, the illumination distribution equalized by the tapered rod lens 20 is further equalized by additional reflections of the light within the main rod lens 121. As a result, the projection type display system in this example can produce images having more uniform brightness distribution.

Exemplary Embodiment 2

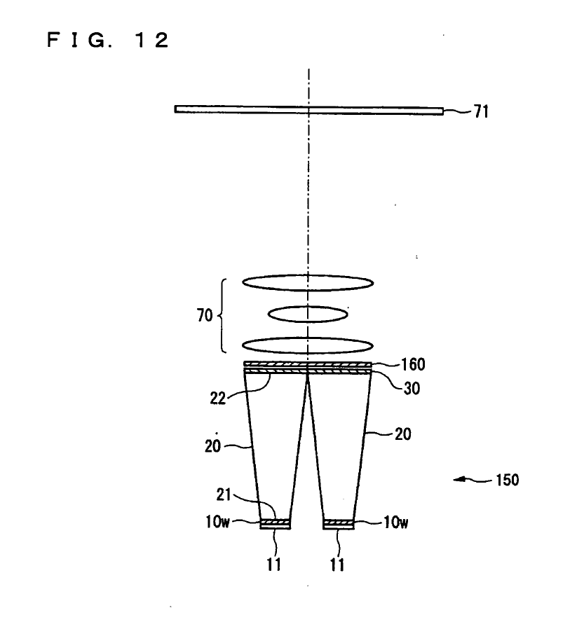

Next, a second exemplary embodiment of the present invention is described with reference to FIG. 12.

A projection type display system in this exemplary embodiment is a mono-plate projection type color display system to produce color images by spatially modulating white light emitted from solid-state light sources by a liquid crystal light valve having a color filter. Similar reference numerals are given to similar components to those in the first exemplary embodiment, and explanation thereof is herein omitted.

FIG. 12 is a schematic of the projection type display system in this exemplary embodiment.

As shown in FIG. 12, the projection type displays system generally includes a lighting device 150 to emit white light, a liquid crystal light valve (light modulating device) 160 to spatially modulate the white light to produce color images, and the projection lenses 70 to project the color images.

The lighting device 150 includes LEDs (solid-state light source) 10w to emit white light as illumination light, the tapered rod lenses 20 to equalize the illumination distribution of the white light, and the WGP 30.

The LEDs 10w emit the white light when power is supplied. The light source reflection films 11 to reflect the light having entered from the light exit side toward the tapered rod lenses 20 again are disposed on the LEDs 10w.

The liquid crystal light valve 160 includes an active matrix type light transmissible liquid crystal panel in which image display pixels are arranged in a matrix. The active matrix type light transmissible liquid crystal panel is so operated as to vary transmittance of incoming light by pixel in accordance with image signals of the R, G and B lights (i.e., to conduct spatial modulation). That is, the transmittance of light is determined in a range from approximately 0% to 100% by controlling voltage applied to a light transmissible electrode of the liquid crystal light valve.

The liquid crystal light valve 160 also includes active matrix type light transmissible liquid crystal cells in TN (Twisted Nematic) mode which use TFTs as pixel switching elements).

Additionally, a color filter (not shown) to convert the white light into the R, G and B lights corresponding to the pixels of the liquid crystal light valve 160 are disposed on a surface of the light valve 160 through which the light enters.

Next, the operation of the projection type display system having the above-described structure is described.

When electric power is supplied to the LED 10w , the LED 10w emits the white light toward the tapered rod lenses 20 as illustrated in FIG. 12.

The white light having entered the tapered rod lenses 20 is collimated (parallelized) while its illumination distribution is equalized, and subsequently the white light is introduced from the end face 22 into the WGP 30.

In the white light (randomly polarized light) having entered the WGP 30, s polarized light which vibrates in a direction parallel to the direction where the A1 ribs 31 (see FIG. 3) extend is reflected, and p polarized light which vibrates in a direction perpendicular to the direction where the A1 ribs 31 extend (A1 ribs arrangement direction) is transmitted.

The s polarized light of the white light reflected by the WGP 30 is again reflected toward the WGP 30 by the light source reflection film 11. While the s polarized light is going back and forth between the WGP 30 and the light source reflection film 11 in the tapered rod lens 20, a part of the s polarized light is converted into p polarized light by the rotation of the polarization direction.

When the light in the p polarized condition reaches the WGP 30, it passes through the WGP 30.

As described above, the p polarized light of the white light having passed through the WGP 30 enters the color filter, where the white light is converted into the R, G and B lights corresponding to the pixels of the liquid crystal light valve 160. The converted R, G and B lights enter the liquid crystal light valve 160, where those lights are modulated in accordance with the image signals so as to generate light to produce color images. The projection lenses 70 enlarge the light to produce color images generated by the liquid crystal light valve 160 and project the light on the screen 71, thereby producing color images.

In the example having the above-described structure, the numbers of the lighting device and the liquid crystal light valve are decreased and the cross dichroic prism is not provided. Thus, the projection type display system can be further small-sized compared with the triple-plate projection type display system.

Exemplary Embodiment 3

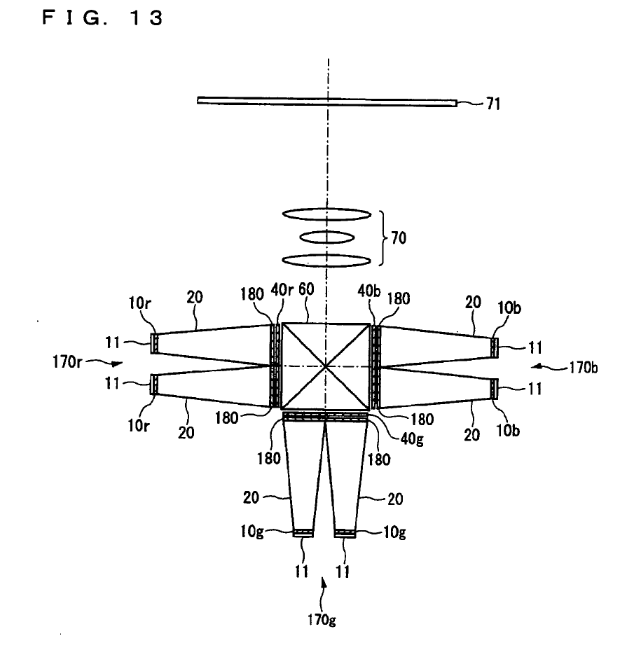

A third exemplary embodiment of the present invention is now described with reference to FIGS. 13 through 15.

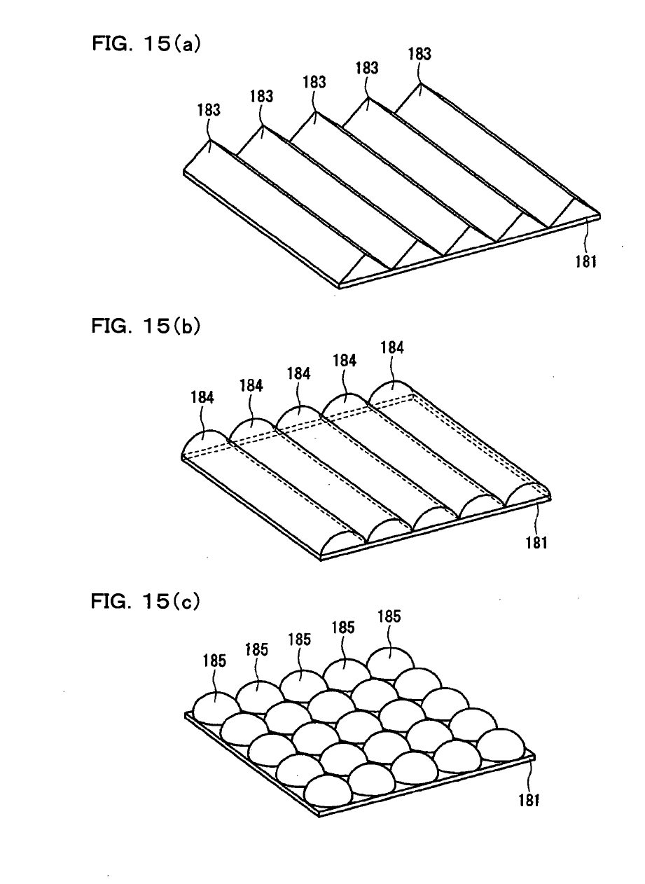

The basic structure of a projection type display system in this exemplary embodiment is similar to that in the first exemplary embodiment, but this exemplary embodiment is different from the first exemplary embodiment in the structure of the lighting devices. Thus, only the lighting devices and their peripherals are explained with reference to FIGS. 13 and 15 in this exemplary embodiment, and the explanation of the cross dichroic prism and other components is omitted.

FIG. 13 is a schematic of the projection type display system in this exemplary embodiment.

As shown in FIG. 13, the projection type display system generally includes lighting devices 170r, 170g and 170b to emit different R, G and B lights, respectively, the liquid crystal light valves 40r, 40g and 40b to spatially modulate the respective lights, the cross dichroic prism 60 to synthesize the modulated respective lights to produce color images, and the projection lenses 70 to project the color images.

The lighting devices 170r, 170g and 170b include the LEDs 10r, 10g and 10b, respectively, to emit lights of respective colors as illumination lights, the tapered rod lenses 20 to equalize the illumination distributions of the respective lights, and light diffusing elements 180 to similarly equalize the illumination distributions.

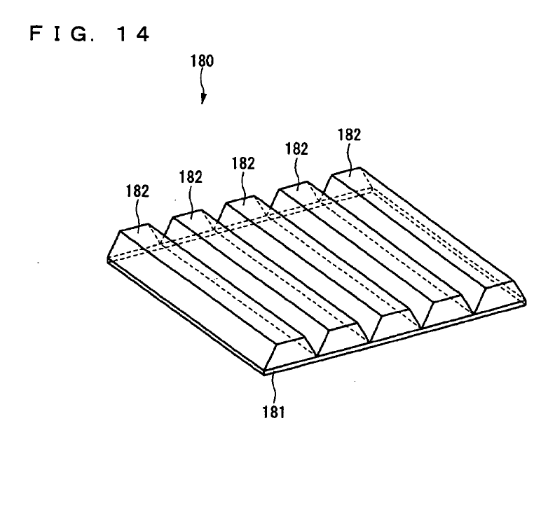

FIG. 14 illustrates the light diffusing element in this exemplary embodiment.

As shown in FIG. 13, the light diffusing element 180 is so formed as to have the same shape as that of the end face 22 of the tapered rod lens 20 and so disposed as to directly contact with the end face 22.

The light diffusing element 180 includes a substrate 181 made from light transmissible material, such as glass and resin and a number of trapezoid poles 182 which are similarly made from light transmissible material and disposed on the substrate 181, as illustrated in FIG. 14. Light enters from the substrate 181 side, and is refracted due to difference in refractive index between the trapezoid pole 182 and its surroundings when the light leaves the trapezoid pole 182.

The light diffusing element 180 may include the trapezoid poles 182 as described above, or may be provided with a number of triangle poles 183 made from light transmissible material as illustrated in FIG. 15(a). Alternatively, the light diffusing element 180 may include a number of semicircle poles 184 as illustrated in FIG. 15(b) or a number of hemispheres 185 as illustrated in FIG. 15(c) both made from light transmissible material.

The light diffusing element 180 may be formed separately from the tapered rod lens 20 as described above, or may be formed directly on the end face 22 of the tapered rod lens 20.

Additionally, the light diffusing element 180 maybe so disposed as to contact the end face 22 as described above, or may be provided inside the tapered rod lens 20, i.e., between the end face 21 and the end face 22.

Next, the operation of the projection type display system having the above-described structure is described.

Since the actions of the lights of the respective colors emitted from the LEDs 10r, 10g and 10b are similar to each other, only the action of the R light emitted from the LED 10r is explained and the description of the actions of the other G and B lights is herein omitted.

When electric power is supplied to the LED 10r, the LED 10r emits the R light toward the tapered rod lenses 20 as illustrated in FIG. 13.

The R light having entered the tapered rod lens 20 is collimated (parallelized) while its illumination distribution is equalized, and is subsequently released from the end face 22.

The R light coming from the end face 22 enters the light diffusing element 180 from the substrate 181 side as illustrated in FIG. 14. Then, the R light is refracted due to difference in refractive index between the trapezoid pole 182 and its surroundings when the light leaves the trapezoid pole 182, thereby further equalizing the illumination distribution.

The R light emitted from the light diffusing element 180 enters the liquid crystal light valve 40r, where the R light is modulated in accordance with the image signals stored in the projection type display system and released toward the cross dichroic prism 60.

Similarly, the G light and the B light which are modulated in accordance with the image signals enter the cross dichroic prism 60. These lights are synthesized by the mirror to reflect the red light and the mirror to reflect the blue light to generate light which produces color images. The generated light to produce color images is released toward the projection lenses 70. The projection lenses 70 enlarge the light to produce color images and project it on the screen 71 so as to produce color images thereon.

According to the above-described structure in which the light diffusing element 180 is disposed on the light exit end face 22 of the tapered rod lens 20, light having more uniform illumination distribution can be emitted without requiring additional means for equalizing the illumination distribution since the illumination distribution which has been equalized by the tapered rod lens 20 is further equalized by the light diffusing element 180. Thus, the projection type display system can be made compact.

While particular exemplary embodiments of the present invention have been shown and described, changes and modifications of the invention may be made without departing from the spirit of the invention.

For example, either the WGPs 30 or the light diffusing elements 180 are provided in the respective exemplary embodiments. But exemplary aspects of the invention are applicable to a structure which includes both of the WGPs 30 and the light diffusing elements 180 simultaneously or other various structures.

When both the WGPs 30 and the light diffusing elements 180 are equipped, it is desirable to dispose the WGP 30 and the light diffusing element 180 in this order from the LED side. This arrangement prevents lowering of the light recycling efficiency by the use of the light source reflection films 11 and the WGPs 30.

1. A lighting device, comprising:
a solid-state light source to emit light;
a light introducing element to equalize an illumination distribution of the light emitted from the solid-state light source; and
a reflection type polarizing element into which the light emitted from the solid-state light source is introduced,
the reflection type polarizing element being disposed inside the light introducing element or on a light exit end face of the light introducing element; and
the solid-state light source reflecting the light which has been reflected by the reflection type polarizing element.

2. A lighting device, comprising:
a solid-state light source to emit light;
a light introducing element to equalize an illumination distribution of the light emitted from the solid-state light source; and
a light diffusing element into which the light emitted from the solid-state light source is introduced,
the light diffusing element being disposed inside the light introducing element or on a light exit end face of the light introducing element.

3. The lighting device as set forth in claim 1, at least a peripheral portion of a light entrance end face of the light introducing element directly contacting a light exit end face of the solid-state light source.

4. The lighting device as set forth in claim 1, the light introducing element being made only from a light transmissible material.

5. The lighting device as set forth in claim 4, a reflection film to reflect light being formed on a surface other than the light entrance end face and the light exit end face of the light introducing element.

6. The lighting device as set forth in claim 1,
the light introducing element being formed by arranging reflection plates to reflect light in the shape of a hollow column; and
inside surfaces of the hollow column including light reflection surfaces of the reflection plates.

7. The lighting device as set forth in claim 1, the shape of the light exit end face of the light introducing element being similar to the shape of an object to be illuminated.

8. The lighting device as set forth in claim 1, the light introducing element having a straight shape whose cross-sectional area is constant from the solid-state light source to the object to be illuminated.

9. The lighting device as set forth in claim 1, the light introducing element having a tapered shape whose cross-sectional area increases from the solid-state light source to the object to be illuminated.

10. The lighting device as set forth in claim 1, a single piece of the solid-state light source corresponding to a single piece of the object to be illuminated.

11. The lighting device as set forth in claim 1, a plurality of the solid-state light sources corresponding to a single piece of the object to be illuminated.

12. A projection type display system, comprising:
a lighting device to emit light;
light modulator to modulate the emitted light; and
a projector device to project the modulated light,
the lighting device being a lighting device as set forth in claim 1.
